(19) United States
(12) Patent Application Publication
(10) Pub. No.: US 2024/0098411 A1
(43) Pub. Date: Mar. 21, 2024

(54) DYNAMIC ADJUSTMENT OF AN OUTPUT OF A SPEAKER

(71) Applicants: Jie GU, Palo Alto, CA (US); Paul X. Wang, Cupertino, CA (US)

(72) Inventors: Jie GU, Palo Alto, CA (US); Paul X. Wang, Cupertino, CA (US)

(21) Appl. No.: 18/119,768

(22) Filed: Mar. 9, 2023

Related U.S. Application Data
(60) Provisional application No. 63/406,650, filed on Sep. 14, 2022.

(51) Int. Cl. H04R 3/04; G10K 11/178

(52) U.S. Cl. CPC H04R 3/04; G10K 11/17881; G10K 2210/12821; H04R 2430/01; H04R 2499/13

(57) ABSTRACT

Adaptively controlling a speaker assembly allows an acoustic characteristic of the speaker assembly to automatically change based on one or more factors. For example, when external noise is detected, the associated noise volume level is determined, and control instructions are generated based on the noise volume level. The control instructions cause the speaker assembly to adaptively increase the volume level to effectively cancel the noise volume. In another example, when a speaker assembly in a vehicle changes from playing a media file to conducting a phone conversation, the volume level associated with the phone conversation may increase. In this regard, control instructions can be generated and used to adaptively reduce the volume level of the phone conversation.

### CROSS-REFERENCE TO RELATED APPLICATIONS

This application claims the benefit of U.S. Provisional Application No. 63/406,650, entitled “DYNAMIC ADJUSTMENT OF AN OUTPUT OF A SPEAKER,” filed Sep. 14, 2022, the entirety of which is incorporated herein by reference.

### TECHNICAL FIELD

This application is directed to a system for controlling audio speaker output, and more particularly, to a system for adaptively adjusting volume level or more acoustic characteristics of an audio speaker based on various received inputs.

### BACKGROUND

An audio speaker outputs sound at a volume level (e.g., decibel or dB, or Watts) set by a user. In the event of nearby noise sources, the user can manually increase the volume level of the audio speaker in order to continue clearly hearing the sound from the audio speaker by interacting with device that drives the audio speaker. For example, the user can turn a dial, press a button, or provide a gesture to touch a screen. In another example, when the device changes the output from playing a media file to initiating a phone conversation, the volume level output by the audio speaker may be significantly higher/lower for the phone conversation than for that of the media file. As a result, the user may wish to manually decrease/increase the volume level, respectively, of the audio speaker.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of an electronic device and a speaker assembly controlled by the electronic device, in accordance with aspects of the present disclosure.

FIG. 2 illustrates a vehicle with a speaker assembly for outputting sound to passengers in the vehicle, in accordance with aspects of the present disclosure.

FIG. 3 illustrates a schematic diagram of a system, in accordance with aspects of the present disclosure.

FIG. 4 illustrates a schematic diagram of a system and an infotainment system, in accordance with aspects of the present disclosure.

FIG. 5 illustrates a graph showing volume level versus input noise, in accordance with aspects of the present disclosure.

FIG. 6 illustrates a graph showing volume level versus input level from multiple inputs, in accordance with aspects of the present disclosure.

FIG. 7 illustrates a graph showing volume level versus time, in accordance with aspects of the present disclosure.

FIG. 8 illustrates a graph showing volume level versus time when the audio source changes, in accordance with aspects of the present disclosure.

FIG. 9 illustrates a method for adaptively altering an output from a speaker assembly, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Speaker assemblies with one or more speakers (e.g., audio output modules) are designed to output sound (e.g., acoustical energy, sound energy) in the form of audio content, such as music, audio tracks corresponding to video content, voices of remote users of electronic devices participating in phone calls or audio and/or video conferences, podcasts, or any other audio content. Speaker assemblies described herein may include a membrane, or diaphragm, driven by a voice coil to produce the audio content. Also, speaker assemblies described herein may be integrated with devices or systems such as home assistant including smart home assistants, as well as vehicles including motorized vehicles, as non-limiting examples.

Electronic devices, such as mobile wireless communication devices (e.g., smartphones, tablet computing devices, wearable devices, etc.) include one or more sensors designed to monitor and obtain ambient information. For example, electronic devices described herein may include a microphone designed to detect sound vibrations in the air and convert the sound vibrations into electrical signals, with the electrical signals used by the electronic device to determine audio characteristics and parameters of the sound. Moreover, the electronic device, in conjunction with the microphone, can determine the volume level (e.g., in dB or Watts), or output volume, of the received sound from one or more speaker assemblies, as well as from other ambient sources. As described in this detailed description and in the claims, the phrases “ambient source” or “ambient sources” may refer to sound source or acoustical source other than a speaker assembly.

In accordance with aspects of the subject technology, an electronic device is able to adaptively control the volume of the speaker assembly based upon one or more inputs received at the electronic device. For example, when the speaker assembly is playing a media file at an initial volume level (e.g., amplitude), the electronic device can determine, using the microphone, the presence of ambient noise that can otherwise diminish a user's ability to hear the speaker assembly at the initial volume level. Based on the volume level of the ambient noise, the electronic device can generate control instructions that cause the speaker assembly to increase/decrease the volume level from the initial volume level, thus causing the speaker assembly to play the media file at a higher/lower volume level, respectively, and effectively addressing the ambient noise. Moreover, the electronic device can generate the control instructions for the speaker assembly automatically, i.e., without user input/interaction. Beneficially, the user is not required to manually interact with the electronic device to adjust the volume of the speaker assembly, as the electronic device is able autonomously perform the task.

In addition to adaptively controlling acoustic characteristics such as volume level, electronic devices described herein can control other acoustic characteristics. For example, the frequency, or range of frequencies, of noise generated by an ambient source can be determined. The frequency can be analyzed and compared with a known frequency of an ambient source. As non-limiting examples, ambient sources with known frequency characteristics include animal noises or vehicular-based noises (e.g., motor noise, motor whine). As a result, an electronic device can generate control instructions for a speaker assembly based on the ambient source, with the ambient source determined by the frequency.

As another example of an acoustic characteristic, the root mean square (RMS) value of noise can be analyzed, thus allowing an electronic device to generate control instructions for a speaker assembly based upon average volume level. Accordingly, the electronic device can ignore noise “spikes” i.e., high noise levels with short durations, and provide control instructions that better reflect the overall received noise. Alternatively, an electronic device can respond to received noise spikes by generating control instructions based on the noise spikes to effectively cancel, for example, noise related to a series of noise spikes. Still further, an electronic device can monitor and determine an average volume level of noise and separately monitor for one or more noise spikes, and generate control instructions based on the average volume level and the noise spikes.

Additionally, the audio source driving (i.e., providing acoustical data to) the speaker assembly may change, which can cause a change in the volume level of the speaker assembly. For example, while an electronic device is playing a media file (i.e., audio file or audio portion of a multimedia/video file) through the speaker assembly, a user may initiate or receive a phone conversation through the electronic device. When the speaker assembly changes from outputting the media file to outputting the phone conversation, the volume level of the phone conversation (e.g., volume of another person's voice) may be greater/louder than that of the media file. However, the electronic device can provide control instructions to the speaker assembly to reduce the volume level of the phone conversation through speaker assembly. The volume reduction may include a reduction to the volume level of the (previously playing) media file, to a predetermined volume (e.g., set for phone conversations), or to a threshold (e.g., minimum or maximum) volume level. Again, the electronic device can automatically and autonomously generate the control instructions for the speaker assembly without user input/interaction.

Other applications may include adaptively adjusting the volume of a speaker assembly integrated with a vehicle. For example, an electronic device can determine the presence of ambient noise within a passenger compartment of the vehicle and provide instructions to increase the volume of the speaker assembly. Ambient noise associated with the vehicle may include environmental noise that enters the passenger compartment when the window is actuated (e.g., opened) or due to the vehicle accelerating on a roadway. The electronic device may communicate with the vehicle through a wired or wireless connection, including through an infotainment system integrated with the vehicle.

Additionally, the vehicle may include an integrated vehicle controller used to adaptively adjust the volume of the speaker assembly without the use of a separate electronic device. For example, the vehicle controller can monitor ambient noise through a built-in microphone. Alternatively, or in combination, the vehicle controller may include a position sensor or other monitoring device that can provide data indicating the window is opened. Using one or more data inputs from the microphone or position sensor, the vehicle controller can generate control instructions to increase the volume of the speaker assembly. By providing techniques and methods for adaptively adjusting the volume without manual user interaction in a vehicle, the volume of the speaker assembly can be conveniently adjusted while providing enhanced safety as the user need not focus on adjusting the volume.

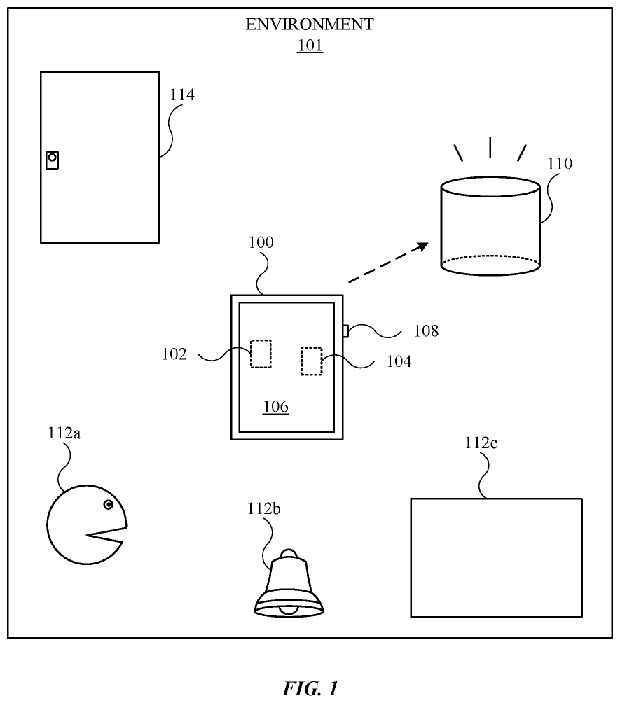

These and other embodiments are discussed below with reference to FIGS. 1-9. However, those skilled in the art will readily appreciate that the detailed description given herein with respect to these Figures is for explanatory purposes only and should not be construed as limiting.

According to some embodiments, for example as shown in FIG. 1, an electronic device 100 is located in an environment 101. The environment 101 may take the form of a room in a home or an office, as non-limiting examples. Generally, the environment 101 can include any space in which one or more persons may occupy.

The electronic device 100 may include a mobile wireless communication device, such as a smartphone, a tablet computing device, a laptop computing device, or a wearable device, as non-limiting examples. The electronic device 100 includes a controller 102 that includes processing circuitry, including control circuitry, which may be part of a central processing unit or an application-specific integrated circuit (ASIC). The controller 102 may further include one or more microcontroller units (MCUs). The controller 102 may access instructions or code stored on memory (not shown in FIG. 1) and use the instructions or code to carry out various processes described herein. Also, the controller 102 is in communication with the various components of the electronic device 100 shown and described below, thus allowing the controller 102 to, for example, receive information or data from the components as well as provide instructions, or controls, for the components.

The electronic device 100 further includes a microphone 104, or audio transducer, designed to detect and convert sound vibrations into electrical current that can be processed as audio signals by the controller 102. Characteristics and parameters, such as the type of audio signal (e.g., random noise, human voice, music, etc.) and the associated volume level, or volume level, can be determined.

The electronic device 100 further includes a display 106. The display 106 may include a capacitive touch input display, and accordingly, the electronic device 100 may receive inputs, commands, or gestures through the display 106. Additionally, the electronic device 100 includes a button 108 (representative of one or more buttons), which is also used to receive an inputs or commands.

Additionally, a speaker assembly 110 is in the environment 101. In some embodiments, the speaker assembly 110 includes an electronic home assistant (e.g., smart home assistant) or a standalone speaker. The speaker assembly 110 may include one or more speakers that can generate and output sound, particularly sound in the range of human hearing.

The electronic device 100 can communicate with the speaker assembly 110 through, for example, a wireless network protocol such as BLUETOOTH® or WIFI®. In this regard, the electronic device 100 can communicate wireless signals and instruct the speaker assembly 110 to output sound, which can take the form of audio sources such as media (e.g., audio file, audio portion of a multimedia) or a caller associated with a phone conversation, as non-limiting examples. The electronic device 100 can further determine whether the speaker assembly 110 is currently active, i.e., outputting sound. Also, the electronic device 100 can manually control the volume level of the speaker assembly 110 when an input is received at the electronic device 100 from the display 106 and/or the button 108.

Additionally, the electronic device 100 can use the microphone 104 to detect sounds (e.g., noise) from one or more ambient sources in the environment 101. For example, the electronic device 100 can receive sound generated from an ambient source 112a, which may include a person representative of one or more people talking in the environment 101. Alternatively, or in combination, the electronic device 100 can receive sound generated from an ambient source 112b, which may include an audio source such as general noise in the environment 101. Alternatively, or in combination, the electronic device 100 can receive sound generated from an ambient source 112c, which may include an activated (i.e., outputting sound) electronic device in the environment 101. It should be noted that the electronic device 100 (as well as other electronic devices described herein) can distinguish between sound generated from the speaker assembly 110 and other sounds generated from any of the ambient sources 112a, 112b, and 112c.

Based on the received sound(s) from one or more of the ambient sources 112a, 112b, and 112c, the electronic device 100 can automatically control (e.g., increase or decrease) the volume level of the speaker assembly 110 without receiving a user input. For example, the electronic device 100 can determine a volume level of one or more of the ambient sources 112a, 112b, and 112c in the environment 101 and generate instructions (e.g., volume control instructions) to increase the volume level of the speaker assembly 110. When the instructions are communicated by the electronic device 100 to the speaker assembly 110, the volume level of the speaker assembly 110 increases. Beneficially, a person (or persons) using the speaker assembly 110 can better and more readily hear the sound generated by speaker assembly 110 notwithstanding sounds emitted from one or more of the ambient sources 112a, 112b, and 112c. Generally, the instructions generated by the electronic device 100 are proportional to the volume level of one or more of the ambient sources 112a, 112b, and 112c. Accordingly, when the electronic device 100 determines the volume level of one or more of the ambient sources 112a, 112b, and 112c as relatively low or high, the instructions generated by the electronic device 100 cause the volume level of the speaker assembly 110 to increase the volume level relatively low or high, respectively. Conversely, when the electronic device 100 determines the volume level of one or more of the ambient sources 112a, 112b, and 112c decreases, the electronic device 100 can generate and communicate instructions to the speaker assembly 110 to proportionally decrease the volume level of the speaker assembly 110.

Also, for the purposes of safety person near the speaker assembly 110, the electronic device 100 will limit the volume level of the speaker assembly in certain situations. For example, the electronic device 100 will not generate and provide control instructions that cause the speaker assembly 110 to increase the volume level, or decibel level, above a level that could potentially damage a person's hearing. This includes instances in which significant ambient noise would otherwise result in control instructions causing the volume level of the speaker assembly 110 to increase to overcome or cancel the significant ambient noise.

In another example, the microphone 104 may detect a door 114 opening, and subsequently generate and communicate instructions to the speaker assembly 110 to reduce the volume level of the speaker assembly 110. This may limit or prevent the sound from the speaker assembly 110 from exiting through the door 114 and/or limit or prevent a person or persons at or near the door 114 from hearing the sound from the speaker assembly 110.

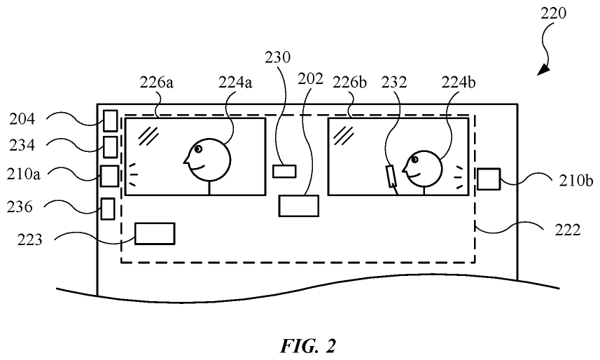

Referring to FIG. 2, a speaker assembly 210a and a speaker assembly 210a are included (integrated or unaffixed) in a vehicle 220, which may be referred to as a motorized vehicle or automobile. Each of the speaker assemblies 210a and 210b may include one or more speakers. The speaker assemblies 210a and 210b can support playing of media files (stored on local memory or streaming through a cloud-based network), radio, and/or phone conversations. The vehicle 220 further includes a controller 202. The controller 202 may include processing circuitry, including control circuitry, that may be part of a central processing unit or an ASIC. The controller 202 may access instructions or code stored on memory (not shown in FIG. 2) and use the instructions or code to carry out various processes described herein. The controller 202 can control the volume level, including the volume level, of the speaker assemblies 210a and 210b, collectively (at the same volume level) and individually (at different volume levels). In this regard, the controller 202 can generate control instructions to adjust the volume level of the speaker assemblies 210a and 210b, including control instructions that cause the speaker assemblies 210a and 210b to output sound at different volume levels. While the controller 202 is shown as being integrated with the vehicle 220, the controller 202 may be part of an electronic device (e.g., electronic device 100 shown in FIG. 1) that is located in a passenger compartment 222 (shown as a dotted line) of the vehicle 220.

The vehicle 220 further includes an audio source 223 designed to drive (i.e., acoustically drive) the speaker assemblies 210a and 210b. The audio source 223 may include a device that provides data to the speaker assemblies to support playing of media files, radio (traditional radio or satellite radio), and/or phone conversations. The audio source 223 may take the form of a built-in audio source (e.g., infotainment system, radio system, satellite radio system) or an electronic device that can connect to and detach from the vehicle 220.

As shown, the passenger compartment 222 is designed to carry one or more passengers, such as a passenger 224a and a passenger 224b. The speaker assemblies 210a and 210b can provide sound that generally throughout the passenger compartment 222, and accordingly, can be heard by the passengers 224a and 224b.

The controller 202 can adjust various acoustic characteristics of the speaker assemblies 210a and 210b in response to one or more changes within the passenger compartment 222. For example, the vehicle 220 includes a window 226a and a window 226b, each representative of additional windows. When one or more of the windows 226a and 226b is actuated (e.g., partially opened or fully opened), noise due to airflow or from one or more ambient sources that is/are externally located with respect to the passenger compartment 222 may nonetheless enter the passenger compartment 222, causing added noise that interferes with the ability of the passengers 224a and 224b to hear the sound from the speaker assemblies 210a and 210b. As non-limiting examples, noise from an ambient source may include airflow noise due to motion of the vehicle 220), speed-related noise due to the rate of travel of the vehicle 220, roadway-related noise due to the roadway on which the vehicle 220 is driving, or a combination thereof. In response to the noise(s), the controller 202 can generate control instructions to increase the volume level of at least one of the speaker assemblies 210a and 210b, thus making it easier for the passengers 224a and 224b to hear the sound from the speaker assemblies 210a and 210b over the received noise through the window 226a and/or the window 226b. The controller 202 can directly send the control instructions to the speaker assemblies 210a and 210b, or indirectly can directly send the control instructions by way of the audio source 223. Conversely, when one or more of the windows 226a and 226b is actuated in the opposite direction (e.g., partially closed or fully closed), the vehicle 220 can generate control instructions to decrease the volume level of at least one of the speaker assemblies 210a and 210b as the noise within the passenger compartment 222 may reduce. Beneficially, the controller 202 can adaptively control the speaker assemblies 210a and 210b can without manual interaction from the passengers 224a and 224b.

The controller 202 may use a sensor 230 to determine a position of the windows 226a and 226b, or to determine motion of a motor (not shown in FIG. 2) that actuates the windows 226a and 226b. As a result, the controller 202 can generate volume instructions based on movement of the window 226a and/or the window 226b. Alternatively, or in combination, the controller 202 can receive noise or other sounds from one or more ambient sources in the passenger compartment 222 from a microphone 204 of the vehicle 220. For example, the microphone 204 can detect voice-related noise from one or more of the passengers 224a and 224b speaking, or from a device 232 (e.g., smartphone, gaming device, etc.) with which the passenger 224b is interacting.

Additionally, when the device 232 is paired/synced with the vehicle 220, the controller 202 can adjust the volume of the speaker assemblies 210a and 210b. For example, using the microphone 204 and/or the paired relationship with the device 232, the controller 202 can determine the device 232 is outputting sound and can also determine the associated volume level. The controller 202 can generate control instructions to increase the volume level of at least one of the speaker assemblies 210a and 210b in order to better hear the sound from the speaker assembly 210a and/or the speaker assembly 210b, and effectively cancel the sound generated by the device 232. Conversely, the controller 202 can generate control instructions to decrease the volume level of at least one of the speaker assemblies 210a and 210b such that the passenger 224b can better hear the sound generated from the device 232 over the speaker assemblies 210a and 210b. Moreover, the controller 202 can generate control instructions to decrease the volume level of the speaker assembly 210b, i.e., the speaker assembly closer (or closest) to the passenger 224b interacting with the device 232, thus cancelling (or at least partially cancelling) the sound from the speaker assembly 210b for the passenger 224b. Still further, when the controller 202 receives information indicating the media played by the device 232 is from an authorized service (e.g., authorized media-based family plan, authorized streaming service, etc.), the controller 202 can switch from the audio source 223, through which the speaker assemblies 210a and 210b are currently playing, to the device 232. Put another way, the device 232 may become the updated audio source through which the speaker assemblies 210a and 210b are playing.

The vehicle 220 may further include an image sensor 234. In some embodiments, the image sensor 234 may include a camera designed to capture a facial image, including a facial expression, of one or more of the passengers 224a and 224b, and transmit the facial image as image data to the controller 202. The controller 202 can receive the image data and determine a facial expression and adjust the volume level of one or more of the speaker assemblies 210a and 210b based on the facial expression. For example, the image sensor 234 may capture a facial image of at least one of the passengers 224a and 224b indicating the passenger cannot hear the volume level of the speaker assemblies 210a and 210b, which may include one of the passengers 224a and 224b cupping a hand next to an ear and/or squinting eyes. Such an expression may correspond with a request from the passenger to increase the volume level of one or more of the speaker assemblies 210a and 210b. The controller 202 can use the facial image as a perceived request and generate control instructions to increase the volume level of at least one of the speaker assemblies 210a and 210b. Conversely, the image sensor 234 may capture a facial image of at least one of the passengers 224a and 224b indicating the passenger believes the volume level of the speaker assemblies 210a and 210b is too loud, which may include one of the passengers 224a and 224b placing hands over ears. Such an expression may correspond with a request from the passenger to decrease the volume level of one or more of the speaker assemblies 210a and 210b. The controller 202 can use the facial image as a perceived request and generate control instructions to decrease the volume level of at least one of the speaker assemblies 210a and 210b. Additionally, the image sensor 234 may capture a facial image of at least one of the passengers 224a and 224b indicating the passenger is looking away and/or has closed eyes, suggesting the passenger has a relatively low interest level (i.e., is disinterested) in the sound provided by the speaker assemblies 210a and 210b. The controller 202 can again use the facial image as a perceived request and generate control instructions to decrease the volume level of at least one of the speaker assemblies 210a and 210b. Moreover, based on the respective passenger locations of the passengers 224a and 224b in the passenger compartment 222, the speaker assembly 210a is closer to the passenger 224a than the passenger 224b, and the speaker assembly 210b being closer to the passenger 224b than the passenger 224a.

Further, the image sensor 234 may provide depth perception, allowing the controller 202 to determine an estimated location of the passengers 224a and 224b. In this regard, the controller 202 may determine the passenger (e.g., passenger 224a and 224b) that provided the facial image, and adjust the speaker assembly (e.g., one of the speaker assemblies 210a and 210b) that is closer to that passenger. Accordingly, by receiving the estimated location and the request from a passenger in the passenger compartment 222, the controller 202 can selectively adjust one of the speaker assemblies 210a and 210b.

The vehicle 220 may further include a temperature control unit 236 that can regulate temperature and airflow from a heating unit or an air conditioning unit (not shown in FIG. 2) of the vehicle 220. The resultant airflow may increase the noise within the passenger compartment 222. The airflow may be determined by an input (e.g., electrical signal) from the temperature control unit 236 to the controller 202. Alternatively, the microphone 204 can detect noise based on the airflow. The controller 202 can generate control instructions to increase the volume level of at least one of the speaker assemblies 210a and 210b in order to effectively cancel the airflow noise. Conversely, when the temperature control unit 236 is turned down or turned off, the controller 202 can generate control instructions to decrease the volume level of at least one of the speaker assemblies 210a and 210b.

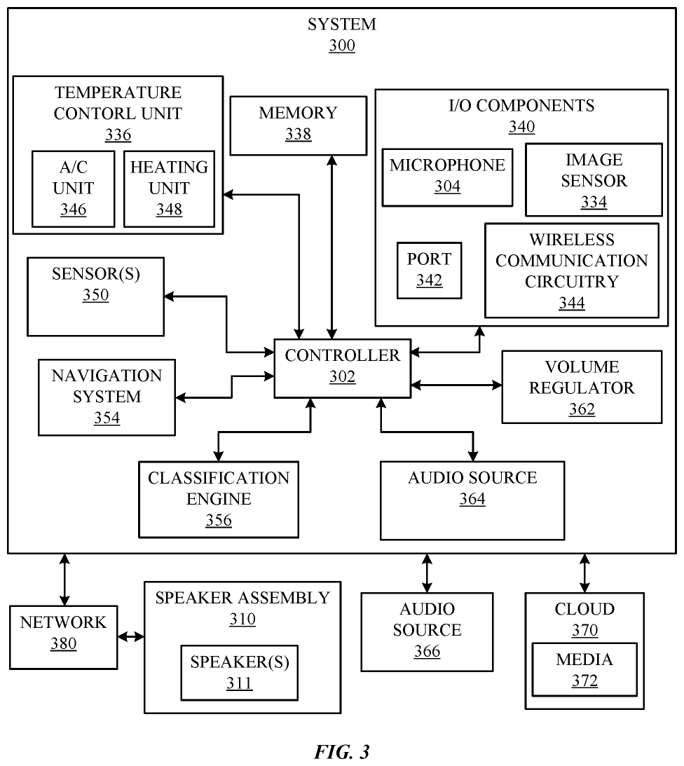

Referring to FIG. 3, a schematic diagram of a system 300 is shown. At least some features of system 300 may allow the system 300 to take the form of an electronic device (e.g., electronic device 100 in FIG. 1) or a vehicle (e.g., vehicle 220 shown in FIG. 2). Some examples provided herein may be described as applying to an electronic device or a vehicle. However, it should be noted that the examples may apply to both an electronic device and a vehicle.

The system 300 includes a controller 302 operatively coupled to a memory 338. The controller 302 may include processing circuitry, including control circuitry, that may be part of a central processing unit or an ASIC. Alternatively, or in combination, the controller 302 may include one or more MCUs. In some embodiments, the controller 302 is part of an electronic device (e.g., smartphone or other mobile wireless communication device) that that takes the form of the system 300 and is separate from a vehicle but in communication with the vehicle. In some embodiments, the controller 302 is integrated with the vehicle, which takes the form of the system 300. When the controller 302 is integrated with the vehicle, the controller 302 can receive various inputs and data, including real-time or near real-time information such as vehicle acceleration and position of window(s), as non-limiting examples. In either of the described embodiments, the controller 302 is operatively connected to various systems and components shown and described for the system 300, thus allowing the controller 302 to receive information and/or provide instructions to the systems and components.

Additionally, the controller is operatively coupled to a memory 338. The memory 338 stores executable instructions and code, thus allowing operation of the controller 302 and various components that will be shown and described for the system 300. The memory 338 may include read-only memory circuitry, random-access memory circuitry, cloud-based memory accessible through a network, or a combination thereof.

The system 300 further includes a speaker assembly 310 (representing one or more speaker assemblies) designed to output sound. The speaker assembly 310 may include one or more speakers 311. The controller 302 can receive instructions/code stored on the memory 338 to control various acoustic characteristics of the speaker assembly 310, including volume level, as a non-limiting example.

The system 300 may include several input-output components 340. For example, the input-output components 340 include a microphone 304 designed to detect sound (e.g., noise) in an environment, such as a room in a home or office, or in a passenger compartment of a vehicle. The input-output components 340 further include a port 342 and wireless communication circuitry 344. The system 300, including the controller 302, may be in communication with the speaker assembly 310 through a wired connection using the port 342. As shown in FIG. 3, the system 300 uses the wireless communication circuitry 344 to communicate with the speaker assembly 310 via a network 380 (e.g., BLUETOOTH® or WIFI®, as non-limiting examples). Using a wired or wireless connection, the system 300 can communicate with the speaker assembly 310 to, for example, determine whether the speaker assembly 310 is actively outputting sound or to provide control instructions to adjust one or more acoustic characteristics of the speaker assembly 310.

The system 300 may further include an image sensor 334. In some embodiments, the image sensor 334 may include a camera designed to capture a facial image, including a facial expression. In this regard, the image sensor 334 may provide data to the controller 302 in any manner described for the image sensor 234 (shown in FIG. 2). Similar to a manner described for the controller 202 and image sensor 234 (both shown in FIG. 2), the controller 302 can receive the image data and determine a facial expression or an interest level of a person and adjust the volume level of the speaker assemblies 210a and 210b based on the facial expression or the interest level, respectively.

The system 300 may further include a temperature control unit 336 used to control an air conditioner unit 346 and a heating unit 348. Accordingly, the temperature control unit 336 can control the climate in a room or a passenger compartment. The temperature control unit 336 can provide data to the controller 302 related to operation of the air conditioner unit 346 and the heating unit 348, as well as the degree (e.g., minimum or maximum) or temperature control level to which the air conditioner unit 346 and the heating unit 348, respectively, are running. The controller 302 can provide instructions to the speaker assembly 310 to adaptively adjust the volume level of the speaker assembly 310. This includes control instructions to increase the volume level of the speaker assembly 310 when the temperature control unit 336 indicates one of the air conditioner unit 346 and the heating unit 348 is running at a relatively high level (corresponding to increase airflow output), and control instructions to decrease the volume level of the speaker assembly 310 when the temperature control unit 336 indicates one of the air conditioner unit 346 and the heating unit 348 is running at a relatively low level or turned off (corresponding to little or no airflow output, respectively). Alternatively, the microphone 304 can detect sound due to airflow from running the temperature control unit 336, provide sound-related data to the controller 302, and the controller 302 can generate control instructions for the speaker assembly 310 based on the input from the microphone 304.

Additionally, the system 300 may include one or more sensors 350 that can determine characteristics of the temperature control unit 336. For example, the one or more sensors 350 may include a temperature sensor that determines local temperature, including local temperature changes. The controller 302 can use the temperature change data to determine to what level the temperature control unit 336 is running the air conditioner unit 346 or the heating unit 348, and generate control instructions for the speaker assembly 310 based on the input from the temperature sensor.

The system 300 further includes a navigation system 354 that communicates with a satellite system (not shown in FIG. 3) to provide location information of the system 300. Using the navigation system 354, the system 300 can determine the type of roadway on which the system 300 is located. Certain roadways may be associated with additional noise. For example, freeways may include a relatively high number of vehicles, a relatively high number of lanes, and vehicles traveling at relatively high speeds. The associated noise on freeways may be greater than that of other roads such as streets. As a result, the controller 302 can receive data related to the roadway information from the navigation system 354 and generate control instructions to adjust the volume level of the speaker assembly 310 based on the roadway information. Generally, the control instructions related to freeways result in increased volume levels for the speaker assembly 310 as compared to other roadways. The navigation system 354 may also provide speed-based information of the system 300, which the controller 302 determine an associated noise due to speed and generate appropriate control instructions based on the speed-based information.

Additionally, the system 300 may include one or more sensors 350 that can determine characteristics of the speed. For example, the one or more sensors 350 may include a speed sensor or an accelerometer used to determine a current speed of the system 300, including a change in speed. The controller 302 can receive speed-based data from the one or more sensors 350, determine associated noise due to the speed, and generate control instructions for the speaker assembly 310 based on the speed-based data.

The system 300 may further include a classification engine 356 designed to receive data related to sound (e.g., noise) received from the microphone 304, and classify the sound within a predetermined acoustical category. For example, the classification engine 356 can classify the sound as short-term noise, such as an animal barking or a horn honking. Alternatively, or in combination, the classification engine 356 can determine an RMS value of noise in order to classify the noise. Using this information from the classification engine 356, the controller 302 may determine not to generate control instructions to increase the volume level of the speaker assembly 310, despite the potentially high-decibel acoustical source. This is due in part to the short duration of the short-term noise. The classification engine 356 may use acoustic characteristics, such as volume level, frequency (including a frequency range or frequency spectrum), and/or average volume of the sound to classify the sound within a predetermined acoustic category.

Alternatively, the classification engine 356 can classify other long-term noise, such as motor noise from a motor running during a long trip or a media file playing in or near the system 300 with a relatively long time duration. Using this information from the classification engine 356, the controller 302 may generate control instructions to increase the volume level of the speaker assembly 310 to a predetermined level, based in part on the classified noise and expected characteristic(s) of the classified noise.

Additionally, the classification engine 356 can receive image data from the image sensor 334 that corresponds to facial expressions of a user or a passenger. The classification engine 356 can interpret the facial expression to determine whether the user/passenger is requesting the volume level of the speaker assembly 310 be increased or decreased, and provide the information to the controller 302 so that the controller 302 can generate corresponding control instructions.

Still further, the classification engine 356 can receive parameters associated with a vehicle. For example, the classification engine 356 can receive characteristics such as vehicle insulation and suspension, as non-limiting example. Generally, the classification engine 356 can receive characteristics that may influence the sound within a passenger compartment of a vehicle that is unrelated to acoustical output of the speaker assembly 310. The classification engine 356 can classify the vehicle in terms of expected noise within the passenger compartment and provide the information to the controller 302 so that the controller 302 can generate corresponding control instructions.

The system 300 may further include a volume regulator 362 designed to limit the volume level of the speaker assembly 310 to a threshold volume level or a specified volume level. In this regard, when the controller 302 generates control instructions to increase or decrease the volume level of the speaker assembly 310 based on received noise from the microphone 304, the volume regulator 362 may limit the respective increase or decrease of the volume level. For example, when the controller 302 receives data related a relatively high noise level from an acoustical source, the volume regulator 362 may can limit a maximum volume level of the speaker assembly 310 to the threshold/specified volume level, as any further increase (i.e., an increase proportional to the high noise level) may damage the speaker assembly 310 and/or cause injury to person in the hearing range of the speaker assembly 310. Conversely, when the controller 302 receives data related a relatively low noise level, the volume regulator 362 may cause control instructions to be limited to a minimum volume level of the speaker assembly 310 to the threshold/specified volume level, as any further decrease (i.e., a decrease proportional to the low noise) may render the volume level of the speaker assembly 310 at an inaudible or muted level. The threshold/specified volume level may be set by a user based upon desired user settings, or by a manufacturer of the system 300 based on safety standards.

Referring again to the one or more sensors 350, the one or more sensors 350 may include a position sensor designed to determine when a window(s) of a vehicle are open, including whether the window(s) is/are partially or fully open. The controller 302 receive data from the position sensor to determine actuation of the window(s) or the movement of the respective motors that actuate the windows. The one or more sensors 350 may further include a pressure sensor that detects pressure changes in a room or a vehicle. Regarding the vehicle, the controller 302 receive data from the pressure sensor to determine whether one or more windows of the vehicle is/are opened. The one or more sensors 350 may further include a proximity sensor that determines an estimated location of persons (e.g., users, passengers) relative to the speaker assembly 310. The proximity sensor may include an ultrasonic sensor, as a non-limiting example. The controller 302 receive data from the proximity sensor to determine which of the one or more speakers 311 of the speaker assembly 310 is/are closer to a particular passenger, and selectively increase or decrease the volume level of the one or more speakers 311.

Further, the controller 302 can receive additional acoustical characteristics of the noise. For example, the controller 302 can receive a frequency, including a frequency spectrum, of the received noise and provided control instructions based on the received frequency. Further, the controller 302 can generate control instructions that cause the frequency of the sound of the speaker assembly 310 to change. This may include increasing or decreasing the frequency based on relatively high frequency or relatively low frequency, respectively, of the noise.

Additionally, the system 300 may include an audio source 364 that takes the form of a media player (e.g., radio, satellite radio, external electronic device, etc.). Also, the system 300 is in communication with an audio source 366, which may include the same functionality as that of the audio source 364 and additionally a communication device that facilitates a phone conversation between two or more persons. During operation, the audio source 364 may provide the source for the media playing through the speaker assembly 310 at an initial volume level, e.g., volume A. However, when the source changes from the audio source 364 to the audio source 366, the volume level from the speaker assembly 310 may automatically change from the initial output to a subsequent volume level, e.g., volume B, that is greater than volume A. However, the controller 302 may automatically adjust the volume level down from volume B to volume A. Alternatively, or in combination, the volume regulator 362 may limit the volume level change (including an increase or decrease in the change). Alternatively, or in combination, the classification engine 356 can classify the source from the audio source 366 as a phone conversation, and provide the classification information to the controller 302, thus allowing the controller 302 to select a specified volume level for the phone conversation. The controller 302 may determine the audio source has changed through input data provided by one of the audio sources 364 and 366, or by input data from the microphone 304 determining a change in volume level of the speaker assembly 310 due to the audio source change

In some embodiments, the system 300 can use the wireless communication circuitry 344 to communicate with a cloud 370, or cloud-based network, to receive media 372. The media 372 may include audio-based media stored on the cloud 370. Further, the media 372 may include authorized media accessible through a service (e.g., authorized media-based family plan, authorized streaming service, subscription-based service, etc.,) which may be determined by, for example, the classification engine 356. In this regard, the controller 302 may receive information indicating the media 372 is categorized as an approved service and generate control instructions to decrease the volume level of the speaker assembly 310 or switch from the audio source 364 to the media 372 on the cloud 370 such that the media 372 plays through the speaker assembly 310. The media 372 may be substituted with another source, such as the audio source 366.

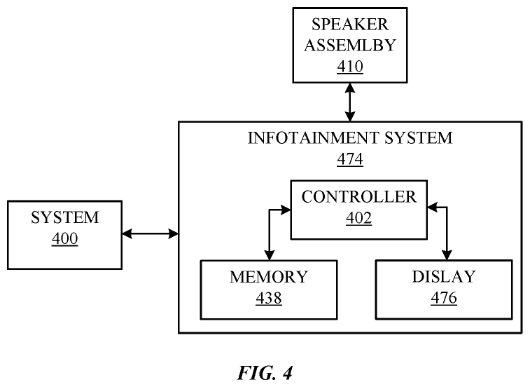

Referring to FIG. 4, a system 400 is in communication with an infotainment system 474. The system 400 may include any system described herein, such as an electronic device or a vehicle. The infotainment system 474 may be integrated with a vehicle described herein. As shown, the infotainment system 474 includes a controller 402 operatively coupled to memory 438 that stores executable instructions or code for the controller 402. The controller 402 is further operatively coupled to a display 476. The display 476 is designed to provide information, which may include information provided by the system 400 when the system 400 includes an electronic device. Alternatively, or in combination, the infotainment system 474 may provide information and controls for various components on the display 476, including a menu of audio sources.

Also, the infotainment system 474 is in communication with the speaker assembly 410. In some embodiments, the system 400 generates and provides control instructions to the speaker assembly 410 through the infotainment system 474. In other embodiments, the controller 402 of the infotainment system 474 generates and provides control instructions to the speaker assembly 410.

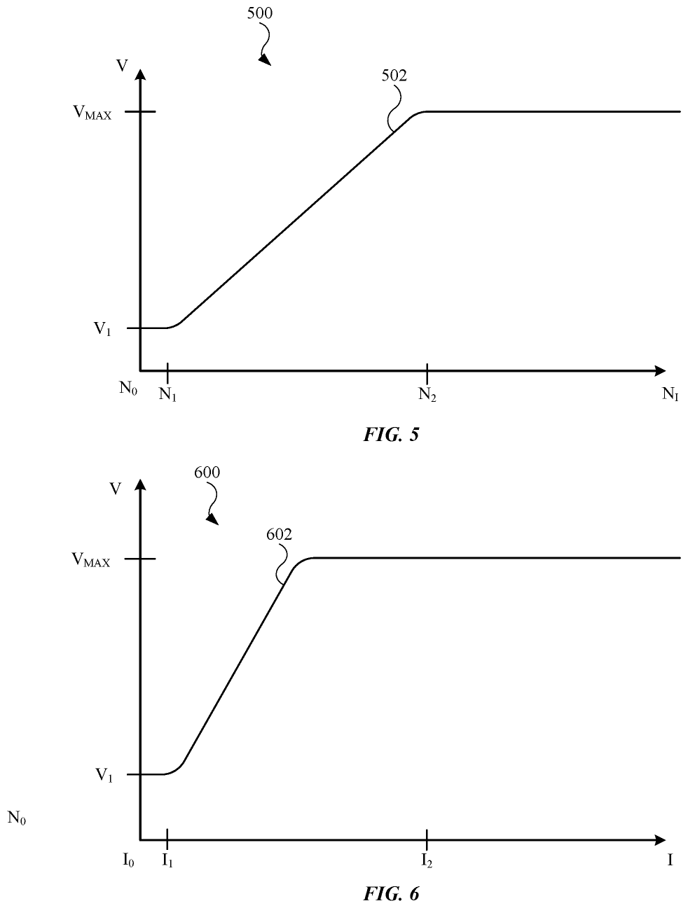

FIG. 5-8 show and describe various features that may be integrated with controllers and control systems described herein to adaptively manage acoustical characteristics of a speaker assembly.

Referring to FIG. 5, a graph 500 showing volume level V for a speaker assembly versus input noise N_{I} is shown. A plot 502 shows the volume level V as the input noise N_{I} increases. For example, from an initial input noise N₀ (representing zero noise or a small noise) to input noise N₁, the volume level remains at V₁, i.e., no volume level change occurs. Accordingly, a controller may receive an indication of some noise at or between N₀ and N₁, but may not generate control instructions to change the volume level V. However, as the input noise increases from N₁ to N₂, the slope of the plot 502 changes. As shown, the volume level V increases in accordance with the increased input noise.

The volume level V may achieve a maximum volume despite increased noise. For example, when the input noise reaches N₂, the slope of the plot 502 shows the volume level V at a maximum volume level V_{O, MAX}, even when input noise increases above input noise N₂. The maximum volume level V_{, MAX} represents a threshold volume level, which may also correspond to a predetermined maximum volume level, or a pre-selected maximum volume level based on a volume regulator. In this regard, the volume level V is limited in order to maintain a user-selected or manufacturer-selected maximum volume level, to prevent damage to the speaker assembly, and/or to prevent injury to users of the speaker assembly.

Referring to FIG. 6, a graph 600 showing volume level V versus input level I is shown. The input level I may refer to a summation of multiple inputs, including, in some cases, all possible inputs, received by a controller used to adjust the volume level V of a speaker assembly. For example, an input level may include noise inputs, data related to facial images (e.g., facial expressions), window auction information, temperature-based information, audio source information, and roadway information, as non-limiting examples. Accordingly, controllers described herein may simultaneously account for multiple inputs and respond by changing the volume level V based on processing the multiple inputs.

A plot 602 shows the volume level V as the input level I increases. For example, from an initial input noise I₀ (representing, for example, zero noise or a small noise, no receipt of a recognized/categorized facial expression, and/or roadway information corresponding to relatively slow vehicle speeds) to input level I₁, the volume level remains at V₁. Accordingly, a controller may receive an indication of some noise and/or data indicating a neutral facial expression at or between input levels I₀ and I₁, but may not generate control instructions to change the volume level V. A neutral facial expression may refer to a facial expression in which a user neither indicates a perceived request for a volume level increase or decrease, or an expression that is not categorized by a classification engine described herein. However, as the input level increases, in terms of the degree/change of the inputs (e.g., noise increase) and/or additional receive inputs (e.g., received c facial images) from input level I₁ to I₂, the slope of the plot 602 changes, indicating the volume level V increasing in accordance with the increased input noise. Moreover, the slope of the plot 602 is greater than that of the plot 502 (shown in FIG. 5), indicating multiple inputs may cause a controller to increase the volume level of a speaker assembly at a greater rate due in part to receipt of additional inputs at the controller.

The plot 602 shows the volume level V may achieve a maximum volume level V_{MAX} despite the input level I increasing that would otherwise cause the volume level V to increase. For example, when the input level reaches I₂, the slope of the plot 602 shows the volume level V at a maximum volume level V_{MAX}. Similar to FIG. 5, the volume level V is limited in order to prevent maintain a user-selected or manufacturer-selected maximum volume level, to prevent damage to the speaker assembly, and/or to prevent injury to users of the speaker assembly.

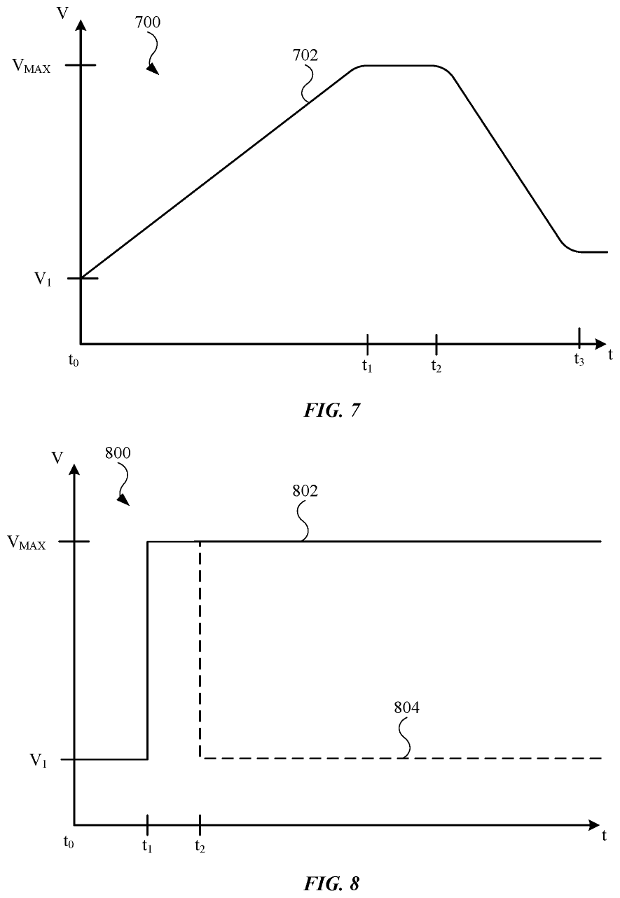

Referring to FIG. 7, a graph 700 showing volume level V versus time t is shown. The graph 700 includes a plot 702 showing the volume level V changing at different times, with the different times corresponding to an updated input, or inputs, received at a controller used to change the volume level of a speaker assembly. For example, from an initial time t₀ to time t₁, the volume level increases from V₁ to V_{MAX}. Accordingly, a controller may receive an indication of an increase in the respective input levels (e.g., noise and/or data indicating a recognized/categorized facial expression), and generate control instructions to increase the volume level V to the maximum volume level V_{MAX}. Moreover, the controller may continuously receive information (e.g., inputs) and continuously provide updated control instructions in real-time or near real-time. From time t₁ to t₂, the input levels may remain steady or increase, while the controller holds a maximum volume level at V_{MAX}. However, from time t₂ to t₃, the input level may decrease, in terms of the degree/change of the inputs (e.g., noise decrease) and/or receive inputs (e.g., neutral facial images). A reduced noise, including a reduce acoustic characteristic of the noise, may include to a controller that the controller is no longer receive information, inputs(s), or data indicating the noise, or acoustic characteristic thereof, ins present. Thus, the controller can provide updated control instructions to decrease the volume level V, may include decreasing the volume level V down to the initial volume level as an example. Accordingly, controllers described herein are designed to both adaptively increase and decrease volume level based on received updates from the inputs.

Referring to FIG. 8, a graph 800 showing volume level V versus time t is shown. The graph includes a plot 802 representing an example in which an audio source for a speaker assembly is changed. As non-limiting examples, the change in the audio source may include a change from a radio to a phone conversation, a change from one electronic device to another electronic device, or a change from one media file to another media file.

From time t₀ to t₁, an initial or first audio source is used to provide electrical signals (corresponding to sound) to control sound generated by a speaker assembly. As shown, the volume level is at V₁. However, at time t1, the audio source is changed to a subsequent or second audio source, causing an immediate or near-immediate increase from volume level V₁ to a maximum volume level V_{MAX}. The plot 802 shows the volume level continuing at the maximum volume level V_{MAX}, indicating the controller can limit the volume level of the second audio source. Alternatively, a plot 804 (shown as a dotted line) shows the volume level reducing from V_{MAX} to V₁ at time t₂. In this regard, a controller may determine the audio source has changed and provide control instructions to reduce the volume level V of a speaker assembly driven by the second audio source from the maximum volume level V_{MAX} to V₁.

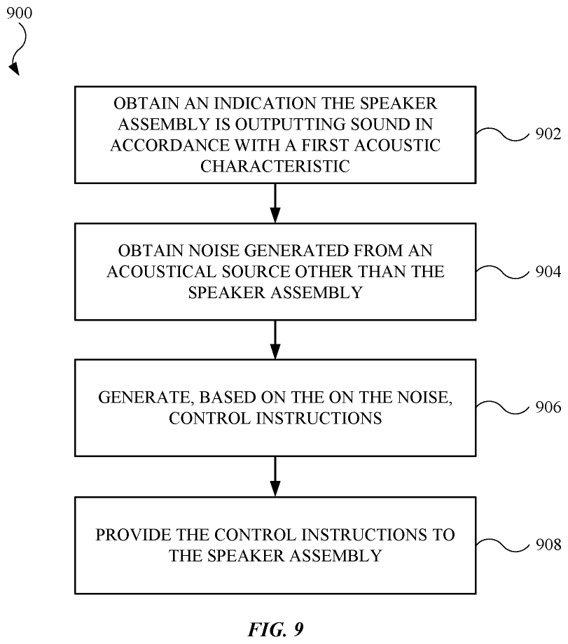

Referring to FIG. 9, a method 900 for adaptively altering an output from a speaker assembly is shown. The speaker assembly may be included in and integrated with a vehicle. The method 900 may be carried out by a controller integrated with electronic devices, vehicles, or infotainments systems integrated with vehicles.

At step 902, an indication the speaker assembly is outputting sound in accordance with a first acoustic characteristic is obtained. As non-limiting examples, an acoustic characteristic may include a volume level or a frequency of the sound. The indication may include an input or data, in the form of an electrical signal, that notifies the controller that the speaker assembly is in use. Additionally, the indication may provide the volume level, i.e., first volume level.

At step 904, noise generated from an acoustical source is obtained. The noise may be located within a passenger compartment of the vehicle, while the acoustical source may inside or outside the passenger compartment. The controller may receive additional data corresponding to the volume level of various noise-generating sources including, but not limited to, passengers talking, noise from an electronic device(s) in the passenger compartment, and environmental noise form an acoustic source located, or originating from, outside of the passenger component. The environmental noise may nonetheless enter the passenger compartment due in part to actuation of a window of a vehicle and/or insulation characteristics of the vehicle. Also, the obtained noise can be analyzed for acoustic characteristics such as volume level, frequency, and/or average volume level.

At step 906, control instructions are generated based on the on noise. In this regard, the control instructions can be based on the volume level, frequency, and/or average volume level of the analyzed noise. The control instructions may be used to offset or even cancel out the noise such that the passengers can better hear the sound from the speaker assembly.

At step 908, the control instructions to the speaker assembly is provided. The control instructions cause the sound to change to a second acoustic characteristic different from the first acoustic characteristic. For example, the first acoustic characteristic and the second acoustic characteristic may include a first volume level and a second volume level, respectively, of the sound from the speaker assembly. Moreover, the volume can adaptively change using the controller and without the manual inputs/command from a passenger in the passenger compartment. Alternatively, the first acoustic characteristic and the second acoustic characteristic may include a first frequency and a second frequency, respectively, of the sound from the speaker assembly.

Various examples of aspects of the disclosure are described below as clauses for convenience. These are provided as examples, and do not limit the subject technology.

Clause A: A method for adaptively altering an output from a speaker assembly for a vehicle, the method comprising: obtaining an indication the speaker assembly is outputting sound in accordance with a first acoustic characteristic; obtaining noise generated from an acoustical source other than the speaker assembly, the noise located within a passenger compartment of the vehicle; generating, based on the on the noise, control instructions; and providing the control instructions to the speaker assembly, wherein the control instructions cause the sound to change to a second acoustic characteristic different from the first acoustic characteristic.

Clause B: An electronic device, comprising: a memory circuit that stores executable instructions; a sensor; and a controller operatively coupled to the memory circuit and the sensor, the controller configured to perform the executable instructions that cause the controller to: obtain data indicating a speaker assembly for a vehicle is outputting sound in accordance with a first acoustic characteristic; obtain, from the sensor, an input; classify the input; generate, based on the classification of the input, control instructions; and provide the control instructions to the vehicle, wherein the control instructions cause the sound from the speaker assembly to change from a first acoustic characteristic to a second acoustic characteristic different from the first acoustic characteristic.

Clause C: A vehicle, comprising: a passenger compartment; a speaker assembly configured to generate sound at least partially throughout the passenger compartment; a memory circuit that stores executable instructions; and a controller operatively coupled to the memory circuit and the memory circuit, the controller configured to perform the executable instructions that cause the controller to: obtain first data indicating the speaker assembly is outputting the sound from a first audio source and in accordance with a first acoustic characteristic; subsequent to the obtained first data, obtain second data indicating the speaker assembly changes to outputting the sound from a second audio source and in accordance with a second acoustic characteristic; responsive to the second acoustic characteristic being different from the first acoustic characteristic, generate control instructions; and provide the control instructions to the speaker assembly, wherein the control instructions cause the speaker assembly to output the sound from the second audio source in accordance with the first acoustic characteristic.

One or more of the above clauses can include one or more of the features described below. It is noted that any of the following clauses may be combined in any combination with each other, and placed into a respective independent clause, e.g., clause A, B, or C.

Clause 1: wherein: the first acoustic characteristic comprises a first volume level, the second acoustic characteristic comprises a second volume level, and the control instructions cause the sound to increase, based a volume level of the noise, from the first volume level to the second volume level.

Clause 2: wherein: receiving the noise from the acoustical source comprises receiving environmental noise based on actuation of a window of the vehicle, and the environmental noise is generated external with respect to the passenger compartment.

Clause 3: wherein: obtaining the noise comprises obtaining a frequency of the noise, and the control instructions are generated based on the frequency.

Clause 4: wherein: the acoustical source comprises airflow controlled by a temperature control unit of the vehicle, and the control instructions cause the sound from the speaker to change based on the noise from the temperature control unit.

Clause 5: further comprising obtaining a threshold acoustic characteristic for the speaker assembly, wherein the threshold acoustic characteristic is less than the second acoustic characteristic, and the control instructions cause the sound to change in accordance with the threshold acoustic characteristic.

Clause 6: wherein: obtaining the noise comprises obtaining a frequency of the noise, and the control instructions are generated based on the frequency.

Clause 7: further comprising classifying the acoustical source within a predetermined acoustical category, wherein the control instructions are generated based on the predetermined acoustical category.

Clause 8: wherein: obtaining the noise comprises obtaining an average volume of the noise, and the control instructions are generated based on the average volume.

Clause 9: further comprising: obtaining image data comprising a passenger located in the passenger compartment; and determining, based on the image data of the passenger, a request from the passenger to adjust the sound of the speaker assembly, wherein the control instructions cause the sound to change based on the request from the passenger.

Clause 10: further comprising: obtaining image data comprising obtaining a facial expression of a passenger; and determining, based on the facial expression, an interest level of the passenger with respect to the sound, wherein the control instructions cause i) a first speaker of the speaker assembly that is closest to the passenger to change the sound to the second acoustic characteristic, and ii) a second speaker of the speaker assembly to maintain the sound at the first acoustic characteristic.

Clause 11: wherein: the sensor comprises a microphone, the first acoustic characteristic comprises a first volume level, the second acoustic characteristic comprises a second volume level, and the controller is further configured to: obtain, from the microphone, the input; and classify the input as motor noise, wherein the control instructions cause the sound to change, based on the motor noise, from the first volume level to the second volume level.

Clause 12: wherein: the sensor comprises a camera; and the controller is further configured to: obtain, from the camera, the input; and classify the input as image data corresponding to a facial image of a passenger located in a passenger compartment of the vehicle, wherein the control instructions cause the sound to change to the second acoustic characteristic based on the facial image.

Clause 13: wherein the controller is further configured to classify the input as environmental noise, wherein the control instructions cause the sound to change to the second acoustic characteristic based on the environmental noise.

Clause 14: wherein the controller is further configured to responsive to the input no longer being obtained by the sensor, generate second control instructions that cause the sound from the speaker assembly to change from the second acoustic characteristic to the first acoustic characteristic.

Clause 15: wherein: the first acoustic characteristic comprises a first volume level, and the second acoustic characteristic comprises a second volume level.

Clause 16: further comprising a camera, wherein: the controller is further configured to: obtain image data from the camera; and classify the image data as a facial image of a passenger located in the passenger compartment, wherein the control instructions cause the sound to change to the second acoustic characteristic based on the facial image.

Clause 17: further comprising an image sensor, wherein: the controller is further configured to receive, using the image sensor, an estimated location of a passenger in the passenger compartment, and the control instructions cause the sound of a speaker of the speaker assembly closest to the estimated location to change to the second acoustic characteristic.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for adaptively altering an output from a speaker assembly for a vehicle, the method comprising:
obtaining an indication the speaker assembly is outputting sound in accordance with a first acoustic characteristic;
obtaining noise generated from an acoustical source other than the speaker assembly, the noise located within a passenger compartment of the vehicle;
generating, based on the on the noise, control instructions; and
providing the control instructions to the speaker assembly, wherein the control instructions cause the sound to change to a second acoustic characteristic different from the first acoustic characteristic.

2. The method of claim 1, wherein:
the first acoustic characteristic comprises a first volume level,
the second acoustic characteristic comprises a second volume level, and
the control instructions cause the sound to increase, based a volume level of the noise, from the first volume level to the second volume level.

3. The method of claim 2, wherein:
receiving the noise from the acoustical source comprises receiving environmental noise based on actuation of a window of the vehicle, and
the environmental noise is generated external with respect to the passenger compartment.

4. The method of claim 1, wherein:
obtaining the noise comprises obtaining a frequency of the noise, and
the control instructions are generated based on the frequency.

5. The method of claim 1, wherein:
the acoustical source comprises airflow controlled by a temperature control unit of the vehicle, and
the control instructions cause the sound from the speaker to change based on the noise from the temperature control unit.

6. The method of claim 1, further comprising obtaining a threshold acoustic characteristic for the speaker assembly, wherein the threshold acoustic characteristic is less than the second acoustic characteristic, and the control instructions cause the sound to change in accordance with the threshold acoustic characteristic.

7. The method of claim 1, wherein:
obtaining the noise comprises obtaining a frequency of the noise, and
the control instructions are generated based on the frequency.

8. The method of claim 1, further comprising classifying the acoustical source within a predetermined acoustical category, wherein the control instructions are generated based on the predetermined acoustical category.

9. The method of claim 8, wherein:
obtaining the noise comprises obtaining an average volume of the noise, and
the control instructions are generated based on the average volume.

10. The method of claim 1, further comprising:
obtaining image data comprising a passenger located in the passenger compartment; and
determining, based on the image data of the passenger, a request from the passenger to adjust the sound of the speaker assembly, wherein the control instructions cause the sound to change based on the request from the passenger.

11. The method of claim 1, further comprising:
obtaining image data comprising obtaining a facial expression of a passenger; and
determining, based on the facial expression, an interest level of the passenger with respect to the sound, wherein the control instructions cause i) a first speaker of the speaker assembly that is closest to the passenger to change the sound to the second acoustic characteristic, and ii) a second speaker of the speaker assembly to maintain the sound at the first acoustic characteristic.

12. An electronic device, comprising:
a memory circuit that stores executable instructions;
a sensor; and
a controller operatively coupled to the memory circuit and the sensor, the controller configured to perform the executable instructions that cause the controller to:
obtain data indicating a speaker assembly for a vehicle is outputting sound in accordance with a first acoustic characteristic;
obtain, from the sensor, an input;
classify the input;
generate, based on the classification of the input, control instructions; and
provide the control instructions to the vehicle, wherein the control instructions cause the sound from the speaker assembly to change from a first acoustic characteristic to a second acoustic characteristic different from the first acoustic characteristic.

13. The electronic device of claim 12, wherein:
the sensor comprises a microphone,
the first acoustic characteristic comprises a first volume level,
the second acoustic characteristic comprises a second volume level, and
the controller is further configured to:
obtain, from the microphone, the input; and
classify the input as motor noise, wherein the control instructions cause the sound to change, based on the motor noise, from the first volume level to the second volume level.

14. The electronic device of claim 12, wherein:
the sensor comprises a camera; and
the controller is further configured to:
obtain, from the camera, the input; and
classify the input as image data corresponding to a facial image of a passenger located in a passenger compartment of the vehicle, wherein the control instructions cause the sound to change to the second acoustic characteristic based on the facial image.

15. The electronic device of claim 12, wherein the controller is further configured to classify the input as environmental noise, wherein the control instructions cause the sound to change to the second acoustic characteristic based on the environmental noise.

16. The electronic device of claim 12, wherein the controller is further configured to responsive to the input no longer being obtained by the sensor, generate second control instructions that cause the sound from the speaker assembly to change from the second acoustic characteristic to the first acoustic characteristic.

17. A vehicle, comprising:
a passenger compartment;
a speaker assembly configured to generate sound at least partially throughout the passenger compartment;
a memory circuit that stores executable instructions; and
a controller operatively coupled to the memory circuit and the memory circuit, the controller configured to perform the executable instructions that cause the controller to:
obtain first data indicating the speaker assembly is outputting the sound from a first audio source and in accordance with a first acoustic characteristic;
subsequent to the obtained first data, obtain second data indicating the speaker assembly changes to outputting the sound from a second audio source and in accordance with a second acoustic characteristic;
responsive to the second acoustic characteristic being different from the first acoustic characteristic, generate control instructions; and
provide the control instructions to the speaker assembly, wherein the control instructions cause the speaker assembly to output the sound from the second audio source in accordance with the first acoustic characteristic.

18. The vehicle of claim 17, wherein:
the first acoustic characteristic comprises a first volume level, and
the second acoustic characteristic comprises a second volume level.

19. The vehicle of claim 17, further comprising a camera, wherein:
the controller is further configured to:
obtain image data from the camera; and
classify the image data as a facial image of a passenger located in the passenger compartment, wherein the control instructions cause the sound to change to the second acoustic characteristic based on the facial image.

20. The vehicle of claim 17, further comprising an image sensor, wherein:
the controller is further configured to receive, using the image sensor, an estimated location of a passenger in the passenger compartment, and
the control instructions cause the sound of a speaker of the speaker assembly closest to the estimated location to change to the second acoustic characteristic.
